(19) United States
(12) Patent Application Publication
(10) Pub. No.: US 2025/0346526 A1
(43) Pub. Date: Nov. 13, 2025

(54) USE OF ENZYMATIC CARBONATE PRECIPITATION TO RAPIDLY BIND MATERIALS IN LOW MOISTURE CONDITIONS

(71) Applicant: Allonnia, LLC, Boston, MA (US)

(72) Inventors: Michaeline Albright; Bianca Cruz, Boston, MA (US); Dayal Saran, Boston, MA (US); Kent Sorensen, Boston, MA (US)

(73) Assignee: Allonnia, LLC, Boston, MA (US)

(21) Appl. No.: 19/202,985

(22) Filed: May 8, 2025

Related U.S. Application Data
(60) Provisional application No. 63/644,413, filed on May 8, 2024.

(51) Int. Cl. C04B 12/00; C04B 22/08; C04B 24/16; C04B 28/00; C04B 40/00; C04B 103/00; C04B 111/00

(52) U.S. Cl. CPC C04B 12/00; C04B 22/08; C04B 24/168; C04B 28/003; C04B 40/0071; C04B 2103/0001; C04B 2103/0079; C04B 2111/00724

(57) ABSTRACT

A method for rapid biocementation of a material under low moisture conditions includes mixing a cell lysate of a urease-producing microbe with the material and, optionally, a calcium source and/or a carbon source, under initial moisture conditions of less than about 15% by weight to form a cementing composition; incubating the cementing composition for a selected time under pressure conditions of between 0 to 1500 bars to form an incubated mixture; and curing the incubated mixture for hours to weeks.

### CROSS-REFERENCE TO RELATED APPLICATION

This application claims priority to U.S. Provisional Application No. 63/644,413 filed on May 8, 2024. The entire contents of the above-referenced application are incorporated herein by reference in their entirety.

### BACKGROUND

Microbiologically induced calcium carbonate precipitation (MICP) is a bio-geochemical process that induces calcium carbonate precipitation within a matrix. Several mechanisms have been identified by which bacteria can induce calcium precipitation including urea hydrolysis, denitrification, sulfate production, and iron reduction. Several applications of this process have been proposed, such as in material science, liquefaction prevention, and sequestration of radionuclides and heavy metals. Enzyme-induced carbonate precipitation (EICP) is a relatively new bio-cementation technique that has been used for ground improvement. In EICP, calcium carbonate (CaCO3) precipitation occurs via urea hydrolysis catalyzed by the urease enzyme from plants, such as jack bean.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for rapid biocementation of a material under low moisture conditions, which includes mixing a cell lysate of a urease-producing microbe with the material and, optionally, a calcium source and/or a carbon source, under initial moisture conditions of less than about 15% by weight to form a cementing composition; incubating the cementing composition for a selected time under pressure conditions of between 0 to 1500 bars to form an incubated mixture; and curing the incubated mixture for hours to weeks.

In another aspect, embodiments disclosed herein relate to a method for rapid biocementation of a material under low moisture conditions, which includes mixing a whole cell microbe fermentation product of a urease-producing microbe with the material and, optionally, a calcium source and/or a carbon source, under initial moisture conditions of less than about 15% by weight to form a cementing composition; incubating the cementing composition for a selected time to form an incubated mixture; and curing the incubated mixture for days to weeks.

In another aspect, embodiments disclosed herein relate to a method for separating an ore material from a suspension. The method includes biocementing the ore material of the suspension. Biocementing the ore material includes mixing a cell lysate of a urease-producing microbe, a whole cell microbe fermentation product of a urease-producing microbe, a calcium source, a carbon source, or combinations thereof with the ore material to form a cementing composition; incubating the cementing composition for a selected time under pressure conditions in a range from 0 bar to 1500 bar, thereby initiating the agglomeration of the ore material and forming an incubated mixture; and curing the incubated mixture for hours to weeks.

Other aspects and advantages of the claimed subject matter will be apparent from the following description and the appended claims.

### BRIEF DESCRIPTION OF DRAWINGS

FIG. 1 is a block flow diagram of a method in accordance with one or more embodiments.

FIG. 2 is a simplified system for separating a material from a suspension in accordance with one or more embodiments.

FIG. 3 is a graph showing the unconfined compressive strength (UCS) of iron ore agglomerates prepared with initial moisture contents of 4% by weight and 6% by weight and curing for 3 days.

FIG. 4 is a graph showing the calcium carbonate content (percent, %) of total material of various control samples compared to the enzyme-induced carbonate precipitation (EICP) reaction.

FIG. 5 is a graph showing UCS of iron ore agglomerates cured for 24 hours.

FIG. 6 is a graph showing UCS of iron ore agglomerates obtained with various cementation solutions.

FIG. 7 is a graph showing UCS of iron ore agglomerates obtained with various cementation solutions.

FIG. 8 is a graph showing UCS of iron ore agglomerates obtained with different curing temperatures and different cementation solutions.

FIG. 9 is a graph showing UCS of iron ore agglomerates obtained with different curing temperatures in the presence and absence of water.

FIG. 10 is a graph showing UCS of iron ore agglomerates obtained with different cementation solutions.

FIG. 11 is a graph showing UCS of iron ore agglomerates obtained with Sporosarcina pasteurii (S. pasteurii) and Escherichia coli.

FIG. 12 is a graph showing UCS of iron ore agglomerates obtained with S. pasteurii grown under different conditions.

FIG. 13 is a graph showing UCS of iron ore agglomerates obtained with different cementation solutions.

FIG. 14 is a graph showing UCS of iron ore agglomerates obtained with different cementation solutions.

FIG. 15 is a graph showing UCS of iron ore agglomerates obtained with different incubation pressures.

FIG. 16 is a graph showing UCS of iron ore agglomerates obtained with different cementation solutions having varying concentrations of calcium chloride.

FIG. 17 is a graph showing UCS of iron ore agglomerates obtained with different curing times.

### DETAILED DESCRIPTION

Before the present methods of making and using bio-cementation for binding of materials are disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

This invention relates to methods of making and using bio-cementation for binding of materials. M ore particularly, the invention relates to binding of materials, such as soils, ores, tailings, and mining substrates, under low moisture conditions. Binding may be achieved via carbonate precipitation, such as microbiologically induced calcium carbonate precipitation (MICP) and enzyme-induced carbonate precipitation (EICP).

It will be appreciated that moisture provides disadvantages in certain applications, and thus it would be advantageous to carry out bio-cementation under low moisture conditions. For example, moisture leads to instability in dry stacking of mining tailings. Also, shipping of materials with a high moisture content is more expensive than would be the case with materials having a low moisture content. Low moisture conditions are also necessary for formation of pellets, when rapid curing is required and does not allow time for microbial growth in the substrate, and for substrates that have high surface tension, where under low moisture conditions water is not easily or evenly dispersed.

In view of the foregoing, it will be appreciated that providing methods of making and using bio-cementation under low moisture conditions and fast reaction times would be a significant advancement in the art.

Throughout the application, ordinal numbers (for example, first, second, third) may be used as an adjective for an element (that is, any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Unless defined otherwise, all technical and scientific terms used herein have the same meanings as commonly understood by one of ordinary skill in the art to which this invention belongs.

As used herein, “comprising,” “including,” “containing,” “characterized by,” and grammatical equivalents thereof are inclusive or open-ended terms that do not exclude additional, unrecited elements or method steps.

As used herein, “fast reaction time” in connection with EICP means a reaction time of less than about 48 hours and in some cases in the range of about 15 minutes to about 24 hours. Fast reaction time also comprises less than about 24, 23, 22, 21, 20, 19, 18, 17, 16, 15, 14, 13, 12, 11, 10, 9, 8, 7, 6, 5, 4, 3, 2, and 1 hours.

Terms such as “approximately” or “substantially” mean that the recited characteristic, parameter, or value need not be achieved exactly, but that deviations or variations, including, for example, tolerances, measurement error, measurement accuracy limitations, and other factors known to those of skill in the art, may occur in amounts that do not preclude the effect the characteristic was intended to provide.

It is to be understood that one or more of the steps shown in the flowcharts may be omitted, repeated, or performed in a different order than shown. Accordingly, the scope disclosed should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

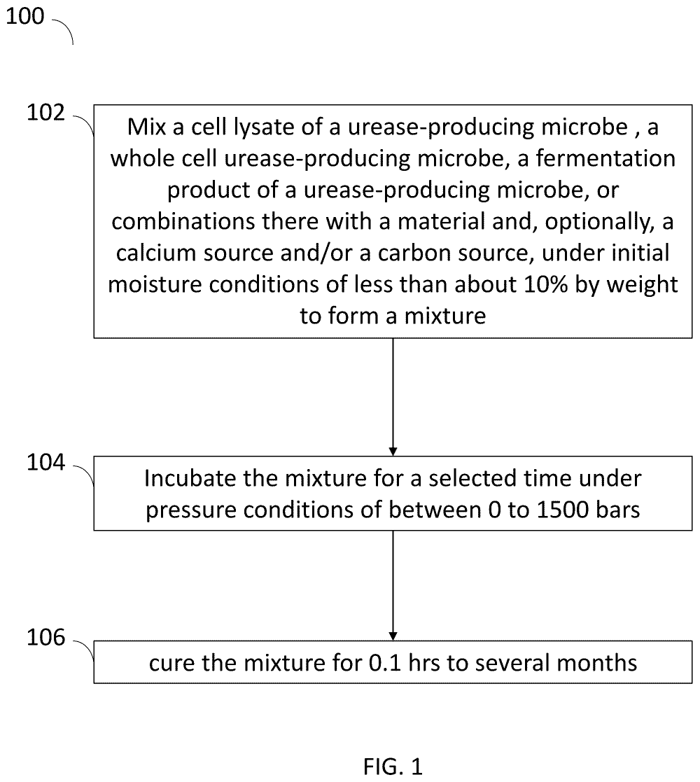

In the following description of FIGS. 1-17, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

The processes of microbially induced calcite precipitation (MICP) and enzyme-induced calcite precipitation (EICP) are generally known and have been applied to multiple applications. In material science, MICP has exhibited high potential for crack cementation of materials such as granite and concrete, manufacture of precast materials, and production of fillers in rubber and plastics. MICP has been proposed as a cementation technique to improve the properties of potentially liquefiable sand. Lead may be immobilized in soil by chelation with the MICP product. It has also been suggested that EICP has potential for strengthening of soils, remediation of contaminants, enhancement of oil recovery through bio-plugging, and other field applications.

Embodiments described herein relate to compositions and methods for cementing ore materials. One or more embodiments described herein are advantageous compared to prior technology for at least the following reasons. Fermentation of urease-producing microbes generates urease and other components (e.g. extracellular polymeric substances (EPS)) that improve calcite precipitation conditions and lead to greater strength of the material as compared to use of purified urease enzyme, commercial urease enzyme, plant urease enzyme, or cell lysate individually, under low moisture conditions. For example, mixing a cell lysate or a whole cell fermentation product of a urease-producing microbe with sodium silicate and/or bentonite and incubating with the ore or tailing material under initial low moisture conditions of less than about 10% by weight leads to significant improvement in the strength of the agglomerate. The mixture may include less than about 5% by weight of the mixture of silicate and/or bentonite. Under conditions described in one or more embodiments herein, MICP or EICP may produce about 0.1% to about 10% by weight carbonate minerals in the material. For example, formation of the carbonate mineral in the presence of silicate polymers of a cementing composition creates a synergistic effect that improves the strength of the agglomerate compared to the individual components.

Another advantage is that the microbial cells and/or cell debris may act as nucleation sites to improve an MICP or EICP process. In particular, most EICP processes discussed in the literature use expensive dried milk powder as a nucleation substrate when using purified enzymes. Additionally, microbial fermentation broth contains components in addition to urease that help to overcome high surface tension properties of some materials. This is particularly beneficial under low moisture conditions. Further, application of the EICP technology in low moisture conditions yields improved cementation results where fast reaction times are required. The costs of using whole cell broth or cell lysate broth are also significantly less than those of using purified commercial enzymes, e.g., commonly jack bean enzymes.

### Cementing Composition

In one aspect, embodiments herein relate to a cementing composition. As used herein, the term “cementing” and/or “biocementing” may refer to the solidification or agglomeration of a material. The cementing composition (or “slurry composition” or “cementing slurry composition”) may include a cell lysate, a whole cell microbe, a fermentation product, or any combination thereof. The cell lysate, the whole cell microbe, a fermentation product, or any combination thereof may be derived from a natural or engineered microbe capable of cementing an ore material. The cell lysate, the whole cell microbe, the fermentation product, or any combination thereof may be obtained from a urease-producing microbe.

The term “fermentation product” refers to a microbial fermentation product. The microbial fermentation product may include a broth that contains urease, cells, intracellular components and/or extracellular components. The fermentation product may include cellular materials that help to overcome high surface tension properties of some materials used in the cementing composition. The term “microbial supernatant” refers to a composition (e.g., a fermentation product solution) that only the extracellular urease enzyme.

The term “cell lysate” may refer to a composition (e.g., a solution) that is derived from cells and includes intracellular and extracellular components. As used herein, a “whole cell microbe” refers to cells including intracellular and extracellular urease enzymes.

The term “microbe” of one or more embodiments may include microorganisms that can induce carbonate precipitation are photosynthetic microorganisms such as cyanobacteria and microalgae, sulfate-reducing bacteria, and some species of microorganisms involved in the nitrogen cycle. In one or more embodiments, the microbe includes or is a urease-producing microbe.

Non-limiting examples of the microbe may include Sporosarcina pasteurii (S. pasteurii), Sporosarcina spp., Bacillus subtilis, Bacillus amyloliquefaciens, Bacillus thuringiensis, Bacillus lentus, Bacillus fortis, Bacillus pumilus, Bacillus megaterium, Bacillus sphaericus, Bacillus cereus, Bacillus mucilaginosus, Lysinibacillus fusiformis, Lysinibacillus xylanilyticus, P seudogracilibacillus auburnensis, Viridibacillus arvi among other natural or engineered microbes that express natural or engineered urease enzymes. S. pasteurii (formerly known as Bacillus pasteurii in older taxonomies), is a gram-positive bacterium with the ability to precipitate calcite and solidify sand when provided with a calcium source and urea via MICP. It is commonly used in MICP because it is non-pathogenic and is able to produce high amounts of urease, which hydrolyzes urea to carbonate and ammonia. In a calcite-rich environment, the negatively charged carbonate ions react with positively charged metal ions, such as calcium, to precipitate calcium carbonate, or bio-cement. The calcium carbonate can then be used as a precipitate or can be crystallized as calcite to cement sand particles together.

The cementing composition may include an ore material. As used herein, the term “ore material” refers to an ore substrate, an ore concentrate, ore (e.g., a metal ore), ore tailings, gangue, waste rock, among other ore-based materials, or any combination thereof. For example, an ore concentrate may be derived from ore tailings. Non-limiting examples of ore material include iron-containing ore material, nickel-containing ore material such as nickel laterite, nickel sulfides, aluminosilicates, bauxite, copper-containing ore material, molybdenum-containing ore material, lithium-containing ore material, ultramafic tailings, among others.

The cementing composition may include a cementing solution. The cementing solution may include a calcium source, a carbon source, microbial growth media, one or more optional additional additives, or any combination thereof. In one or more embodiments, the cementing composition includes a calcium source and/or a carbon source. The calcium source may include a calcium salt including, but not limited to, calcium chloride, calcium acetate, calcium carbonate, calcium sulfate, among other calcium containing compounds. The calcium salt may include a calcium ion that is capable of participating in calcite precipitation. The carbon source may include a urea-based compound including, but not limited to, urea, thiourea, guanidine, among other carbon containing compounds.

The calcium source may be present in the cementing composition at a concentration in a range from 0 to 3 M (molar). The calcium source may be present in the cementing composition in an amount having a lower limit of any one of 0 mM (millimolar), 0.1, 0.5 mM, 0.75 mM, 1 mM, 1.5 mM, 2.5 mM, 5.0 mM, 10.0 mM, 25.0 mM, 50 mM, 75 mM, 100 mM, 150 mM, 200 mM, 250 mM, 500 mM, 750 mM, 1M, 2M, and 3M and an upper limit of any one of 0.1 mM, 0.5 mM, 0.75 mM, 1 mM, 1.5 mM, 2.5 mM, 5.0 mM, 10.0 mM, 25.0 mM, 50 mM, 75 mM, 100 mM, 150 mM, 200 mM, 250 mM, 500 mM, 750 mM, 1M, 2M, 3M, where any lower limit can be paired with any mathematically compatible upper limit.

The carbon source may be present in the cementing composition at a concentration in a range from 0 to 5 M (molar). The carbon source may be present in the cementing composition in an amount having a lower limit of any one of 0, 0.1 mM (millimolar), 0.5 mM, 0.75 mM, 1 mM, 1.5 mM, 2.5 mM, 5.0 mM, 10.0 mM, 25.0 mM, 50 mM, 75 mM, 100 mM, 150 mM, 200 mM, 250 mM, 500 mM, 750 mM, 1M, 2M, and 3M and an upper limit of any one of 0.1 mM, 0.5 mM, 0.75 mM, 1 mM, 1.5 mM, 2.5 mM, 5.0 mM, 10.0 mM, 25.0 mM, 50 mM, 75 mM, 100 mM, 150 mM, 200 mM, 250 mM, 500 mM, 750 mM, 1M, 2M, 3M, 4M, and 5M, where any lower limit can be paired with any mathematically compatible upper limit.

The cementing composition may include one or more optional additional additives, such as a viscosity modifying agent. The one or more optional additional additives may be included in the cementation composition as long as the one or more optional additional additives does not interfere with the agglomeration of the cementation composition. For example, the viscosity modifying agent may be any agent that modifies viscosity that promotes agglomeration (or the “cementing”) of the cementation composition. The viscosity modifying agent may include, but is not limited to, polysaccharides, silicate compounds, clay-based modifiers, or combinations thereof. Non-limiting examples of a viscosity modifying agent include xanthan gum, sodium silicate, bentonite, or combinations thereof.

The one or more optional additional additives may be present in the cementing composition in an amount in a range from 0% by weight to about 10% by weight based on the total weight of the cementing composition. In one or more embodiments, the one or more optional additional additives is present in an amount having a lower limit of any one of 0, 0.5, 1.0, 1.5, 2.0, 2.5, 3.0, 3.5, 4, 4.5, 5.0, 5.5, 6.0, 6.5, 7.0, 7.5 and 8.0 and an upper limit of any one of 1.0, 1.5, 2.0, 2.5, 3.0, 3.5, 4, 4.5, 5.0, 5.5, 6.0, 6.5, 7.0, 7.5, 8.0, 8.5, 9.0, 9.5, and 10.0% by weight based on the total weight of the cementing composition, where any lower limit can be paired with any mathematically compatible upper limit.

The cementing composition may include low moisture conditions. As used herein, “low moisture” generally refers to a water content of a cementing composition having conditions of less than about 15% moisture by weight of the total cementing composition. For example, the phrase “low moisture conditions” may refer to a cementing composition having less than about 15% moisture by weight of the total cementing composition, less than about 12% moisture by weight of the total cementing composition, less than about 10% moisture by weight of the total cementing composition, less than about 9% moisture by weight of the total cementing composition, less than about 8% moisture by weight of the total cementing composition, less than about 7.5% moisture by weight of the total cementing composition, less than about 7% moisture by weight of the total cementing composition, less than about 6% moisture by weight of the total cementing composition, less than about 5% moisture by weight of the total cementing composition, less than about 4% moisture by weight of the total cementing composition, less than about 3% moisture by weight of the total cementing composition, less than about 2% moisture by weight of the total cementing composition, or less than about 1% moisture by weight of the total cementing composition.

In one or more embodiments, the cementing composition includes moisture in the range from about 3% by weight to about 15% by weight moisture based on the weight of the total cementing composition. The phrase “low moisture” refers to a cementing composition having moisture in a range having a lower limit of any one of 1%, 2%, 3%, 4%, 5%, 6%, 7%, 8%, and 10% and an upper limit of any one of 2%, 3%, 4%, 5%, 6%, 7%, 8%, 9%, 10%, 11,%, 12%, 13%, 14%, and 15% by weight based on the total weight of the cementing composition, where any limit can be paired with any mathematically compatible upper limit.

In one or more embodiments, the cementing composition includes an aqueous solution. The aqueous solution includes water. The water may include, but is not limited to, Milli-Q water, distilled water, deionized water, tap water, fresh water from surface or subsurface sources, formation water, natural and synthetic brines, brackish water, natural and synthetic sea water, water obtained from mining processes, potable water, non-potable water, process water, other waters, and combinations thereof, that are suitable for use for treating a copper-containing ore and/or a concentrate thereof. As used herein, “Milli-Q water” is water purified using a Millipore Milli-Q laboratory water system. In one or more embodiments, the basic Milli-Q water meets ASTM Type I standards, having greater than 18.0 MegaOhms·centimeter (MΩ·cm) resistivity at 25° C. due to ions, less than 10 parts per billion (ppb) organics, less than 0.03 endotoxin per milliliter (EU/mL) of pyrogens, less than 1 particulate per mL (particulate/mL), less than 10 ppb silica, and less than 1 bacterial colony forming unit per mL (cfu/mL).

In one or more embodiments, the water used may naturally contain contaminants, such as salts, ions, minerals, organics, and combinations thereof, as long as the contaminants do not interfere with cementing of an ore material. In one or more embodiments, one or more additives may be added to the extraction composition to enhance the selectivity for one or more components, efficiency for removing the one or more components, or combinations thereof.

### Method for Biocementation Under Low Moisture Conditions

In another aspect, embodiments herein relate to a method for biocementation of a material under low moisture conditions. The method may include “biocementing” or “cementing” of an ore material described previously. A method in accordance with one or more embodiments may be as shown in FIG. 1.

In block 102 of FIG. 1, method 100 may include mixing a cell lysate, a whole cell microbe, a formation product, or any combination thereof with an ore material. In some embodiments, a cell lysate, a whole cell microbe, a formation product, or any combination thereof mixed with an ore material forms a cementing composition. In one or more embodiments, a calcium source, a carbon source, or combinations thereof is mixed with the mixture including the ore material and the cell lysate, the whole cell microbe, the formation product, or any combination thereof to form the cementation composition.

In one or more embodiments, the cementing composition is formulated to have low moisture conditions. The moisture conditions (or “water content”) of the cementing composition may be adjusted to a value as described previously. Adjusting the moisture conditions of the cementing composition may include adding water to the cementing composition or removing water from the cementing composition (e.g., filtration, evaporation, among other techniques known to those skilled in the art).

Mixing the cementing composition may include introducing one or more selected from an ore material, a cell lysate, a whole cell microbe, a fermentation product, a calcium source, and a carbon source in a vessel of a biocementation system. The vessel may include one or more components (e.g., a stirring unit, an agitation unit, etc.) that are capable of mixing a slurry, such as a cementing composition. In some embodiments, the vessel of a biocementation system is capable of incubating the cementation composition. The vessel may be in fluid communication, solid communication, or both with an incubation unit of the biocementation system such that the cementing composition is passed from the vessel to an incubation unit.

As shown in block 104 of FIG. 1, the cementing composition is incubated for a selected time to form an incubated mixture. The cementing composition may be incubated under temperatures in a range having a lower limit of any one of 15° C. to 100° C. For example, the incubation temperature may be in a range having a lower limit of any one of 15, 20, 25, 30, 35, 40, 45, 50, 55, 60, 65, 70, 75, 80, 85, and 90° C. and an upper limit of any one of 50, 55, 60, 65, 70, 75, 80, 85, 90, 95, and 100° C., where any lower limit can be paired with any mathematically compatible upper limit.

The cementing composition may be incubated under pressure conditions in a range having a lower limit of any one of 0 bar, 1, 5, 10, 15, 20, 25, 30, 40, 50, 75, 100, 150, 200, 250, 300, 350, 400, 450, 500, 550, 600, 650, 700, 750, 800, 850, 900, 950, and 1000 bars and an upper limit of any one of 75, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, and 2000 bars, where any lower limit can be paired with any mathematically compatible upper limit.

The cementing compositions may be incubated under pressure conditions in a range from 5 kiloNewtons (kN) to 500 kN. The cementing composition of one or more embodiments may be incubated under pressure conditions in a range having a lower limit of any one of 5, 6, 7, 8, 9, 10, 12.5, 15, 17.5, 20, 25, 30, 40, 50, 75, 100, and 150 kN and an upper limit of any one of 50, 60, 70, 80, 90, 100, 110, 120, 130, 140, 150, 160, 170, 180, 190, 200, 225, 250, 275, 300, 350, 400, 450, and 500 kN, where any lower limit can be paired with any mathematically compatible upper limit.

In some embodiments, the pressure conditions, an amount of one or more components of a cementation solution, an amount of a whole cell microbe, an amount of a urease enzyme, cell lysate, fermentation product, and/or a ratio of the cementing solution, one or more components of a cementing solution, or a microbe or urease to a material can be predetermined by transporting a portion of the material to a laboratory and determining pressure conditions, one or more components of a microbial mixture, and/or ratio of a microbial mixture to a material based on compressive strength tests performed in the laboratory on the resultant cured composite. Predetermining the pressure conditions, one or more components of a microbial mixture, and/or a ratio of one or more components of the microbial mixture to the material may include determining a composition of the material. Determining the composition of the material may be performed by one or more analytical methods known to those skilled in the art (e.g., high performance liquid chromatography, energy dispersive spectroscopy, X-ray photoelectron spectroscopy, gas chromatography, mass spectrometry, Fourier transform infrared spectroscopy, among others). Based on the composition of the material, predetermining the pressure conditions may include altering one or more components of the microbial mixture, adjusting a ratio of the one or more components of the microbial mixture to the material, or both.

In one or more embodiments, the incubation unit includes a molding unit such that the cementing composition is introduced to the molding unit of the incubation unit from the mixing vessel. The incubation unit may be the molding unit such that the “incubation” of the cementing composition refers to the molding of the cementing composition. The molding unit may compress the cementing composition to promote particle aggregation and agglomeration and form the incubated mixture. Incubating the cementing composition may be performed for a select period of time, such as a period of time in a range from 2 seconds to 60 minutes. For example, incubating the cementing composition may be performed for a period of time in a range having a lower limit of any one of about 2 seconds, 5 seconds, 10 seconds, 15 seconds, 20 seconds, 30 seconds, 45 seconds, 60 seconds, 2 minutes, 5 minutes, 10 minutes, 15 minutes, 20 minutes, 30 minutes, and 45 minutes and an upper limit of any one of 20 seconds, 30 seconds, 45 seconds, 60 seconds, 2 minutes, 5 minutes, 10 minutes, 15 minutes, 20 minutes, 30 minutes, 45 minutes, and 60 minutes, where any lower limit can be paired with any mathematically compatible upper limit.

In some embodiments, the incubating the cementing composition is performed in the molding unit. The molding unit may include a mold such as a press mold (e.g., a hydraulic press mold, a press filter, or combinations thereof). The incubation unit may include one or more components to control the incubation temperature, incubation pressure, incubation time, or combinations thereof such that the incubating step includes operating the molding unit such that pressure is applied. In one or more embodiments, the incubating step includes operating the molding unit to apply pressure, adjust temperature, or both for a selected period of time. In one or more embodiments, the incubating step promotes the agglomeration of the cementing composition to form the incubated mixture. The incubated mixture may be an agglomerate having an undefined shape. The incubation unit may form the incubated mixture into a pre-defined shape including, but not limited to, spheres, pyramids, cuboids (e.g., blocks, bricks, rounded cubes, etc.), prisms, polyhedral shapes, other three-dimensional shapes, or any combinations thereof.

In one or more embodiments, the incubation step is performed until a pressure is reached within the molding unit of the incubation unit. Once the pressure is achieved, the incubation step may be terminated, and the incubated mixture may be subjected to further curing. In one or more embodiments, incubating the mixture is capable of initiating the cementing process such that curing of the mixture may be performed and/or initiated in the press mold. For instance, the mixture may be compressed in the press mold for a period of time until the press mold reaches a predetermined pressure. In some embodiments, the incubation step occurs from the initiation of the operation of the press mold until the predetermined pressure is achieved.

In one or more embodiments, the incubated mixture is cured as shown in block 106 of FIG. 1. In some embodiments, the incubation mixture is cured in the incubation unit of a biocementation system. For example, the incubation mixture may be cured at a predetermined pressure in a press mold for a predetermined period of time to allow for the formation of a cemented composition. In one or more embodiments, the biocementation system may include a curing unit such that the incubation mixture is transferred from the incubation unit to the curing unit for curing. For example, the incubation mixture may be transferred from a press mold to a separate area or unit for curing such that a subsequent biocemented mixture may be formed from a subsequent incubation mixture that is introduced into the press mold.

The curing (e.g., block 106 of FIG. 1) may be performed in a range having a lower limit of any one of 0.01 hrs (hours), 0.05 hrs, 0.08 hrs, 0.1 hrs, 0.15 hrs, 0.2 hrs, 0.25 hrs, 0.5 hrs, 1.0 hrs, 1.5 hrs, 2.0 hrs, 2.5 hrs, 3.0 hrs, 3.5 hrs, 4.0 hrs, 5.0 hrs, 7.5 hrs, 10.0 hrs, 12.5 hrs, 15 hrs, 17.5 hrs, 20 hrs, 22 hrs, 24 hrs, 30 hrs, 35 hrs, 40 hrs, 48 hrs, 72 hrs, 5 days, 7 days, 1.5 weeks, 2 weeks, 3 weeks, 1 month, 2 months, and 3 months and an upper limit of any one of 1.0 hrs, 1.5 hrs, 2.0 hrs, 2.5 hrs, 3.0 hrs, 3.5 hrs, 4.0 hrs, 5.0 hrs, 7.5 hrs, 10.0 hrs, 12.5 hrs, 15 hrs, 17.5 hrs, 20 hrs, 22 hrs, 24 hrs, 30 hrs, 35 hrs, 40 hrs, 48 hrs, 72 hrs, 5 days, 7 days, 1.5 weeks, 2 weeks, 3 weeks, 1 month, 2 months, 3 months, 4 months, 5 months, and 6 months, where any lower limit can be paired with any mathematically compatible upper limit.

The incubated mixture may be cured under temperatures in a range having a lower limit of any one of 10° C. to 125° C. For example, the incubation temperature may be in a range having a lower limit of any one of 10° C., 15, 20, 25, 30, 35, 40, 45, 50, 55, 60, 65, 70, 75, 80, 85, and 90° C. and an upper limit of any one of 50, 55, 60, 65, 70, 75, 80, 85, 90, 95, 100, 105, 110, 115, 120, and 125° C., where any lower limit can be paired with any mathematically compatible upper limit.

### Method for Separating a Material from a Suspension

In another aspect, embodiments herein relate to a method for separating a material (e.g., an ore material) from a suspension. The method may include “biocementing” or “cementing” an ore material as described previously (e.g., as described in method 100 of FIG. 1). The method for separating a material from a suspension may include obtaining or receiving a suspension.

The suspension may include a fluid and a solid material (e.g., an ore material). The term “suspension” may refer to a fluid having an ore material as described previously. In some embodiments, the suspension includes or is a fluid obtained from a mining site. The suspension may be obtained or received from a mining process, such as a process that produces ore tailings in a fluid. In one or more embodiments, the solid material is concentrated in the suspension prior biocementation. The solid material may be concentrated in the suspension via removal of the fluid from the suspension, thereby forming a concentrated suspension. Fluid may be removed from the suspension before, during, and/or after the initiation of the biocementing process.

Biocementing the ore material may be performed prior to passing the suspension through a filter of a filtration device. In one or more embodiments, biocementing the ore material is performed when the ore material is present in a filter cake on a filter of the filtration device. The filtration device of one or more embodiments may include a press filter.

A moisture content of a suspension may be reduced prior to biocementing the ore material. Fluid may be removed from the cementing mixture before, during, or after the initiation of the biocementing process. The method of one or more embodiments may include removing a fluid (e.g., a carrier fluid) from the cementing mixture via filtration, gravity separation, centrifugation, compression, decantation, or combinations thereof. In some embodiments, fluid is removed from the cementing mixture such that a moisture content of the cementing mixture is reduced to a value of 20 wt % or less, such as 15 wt % or less, 10 wt % or less, or 5 wt % or less.

A cementation solution including one or more of a whole cell microbe, whole cell lysate, cell lysate, a fermentation product, or any combination thereof may be introduced to the suspension, the concentrated suspension, or combinations thereof to form a precursor to a cementing slurry composition. The precursor to the cementing composition, the cementing composition, or both may be incubated and cured as described previously herein (e.g., as described in method 100 of FIG. 1).

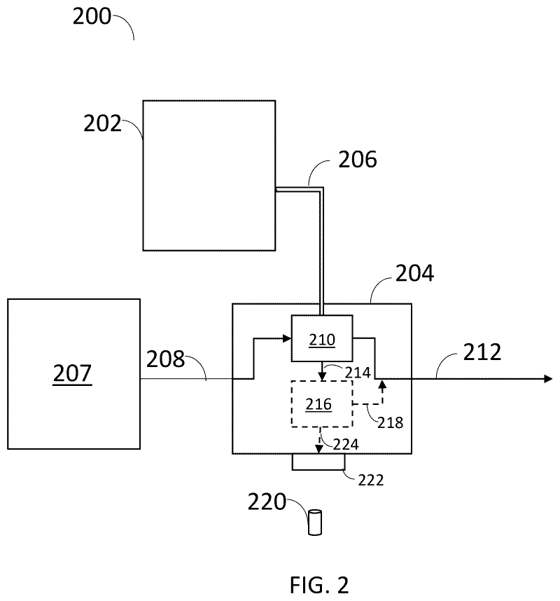

The method may include providing a system for separating a material from a suspension. In one or more embodiments, a system can be adapted to an on-site location (e.g., a mining site) such that a material is separated from a fluid at or proximate to the location of origin of the material. The separated fluid may be reused at the on-site location. A non-limiting example of a separation system may be a system 200 as shown in FIG. 2. System 200 may be configured for batch cementing processes or continuous cementing processes. System 200 includes a material collection unit 202 which is in fluid communication with a cementing unit 204.

In one or more embodiments, the material of a suspension is preconcentrated in a collection unit (e.g., collection unit 202 of system 200) to a moisture content of 75 wt % or less, such as 70 wt % or less, 65 wt % or less, 60 wt % or less, 55 wt % or less, 50 wt % or less, or 45 wt % or less. Preconcentrating the material of a suspension in a collection unit 202 may include removing fluid from the suspension via filtration, gravity separation, centrifugation, compression, decantation, or combinations thereof. Collection unit 202 may be in fluid communication, solid communication, or combinations thereof with cementing unit 204 via transport line 206.

As shown in FIG. 2, system 200 includes a microbial source unit 207. Microbial source unit 207 may be configured to transport a, an enzyme, a cell lysate, a microbe, a carbon source, a calcium source, one or more optional additional additives, a cementing solution, or combinations thereof to cementing unit 204 via one or more transport lines (e.g., a transport line represented by 208). Cementing unit 204 includes an incubation unit 210 and, optionally, a curing unit 216. Incubation unit 210 is configured to receive the material from collection unit 202 via transport line 206 and one or more components from material source unit 207.

In one or more embodiments, the cementation composition is formed (e.g., mixed) in incubation unit 210. Incubation unit 210 may include one or more components capable of incubating a mixture as described previously (e.g., block 104 of FIG. 1). In some embodiments, the cementation composition is formed having a moisture content above 15% by weight moisture in incubation unit 210. In such embodiments, incubation unit 210 may include a filtration apparatus such that the moisture content is reduced to less than 15% by weight prior to incubation of the mixture. Incubation unit 210 may include a press filter such that the moisture in the cementation composition is reduced during the incubation of the mixture. Mixing the cementation composition in incubation unit 210 may provide a filtration aid by agglomerating at least a portion of the solids in the suspension obtained from collection unit 202.

System 200 may advantageously allow for the conservation of fluids, which may be reused at the site (e.g., a mining site), transported to an off-site location, or combinations thereof. Incubation unit 210 includes effluent line 212 such that excess water can be recovered from incubation unit 210. The excess water may be reused in one or more mining process, be transported away from the site for use at an off-site location, or any combination thereof.

Curing may occur in curing unit 216. For example, in embodiments in which curing unit 216 is present in system 200, incubation unit 210 may be configured to produce an incubation mixture. The incubation mixture may be transferred to curing unit 216 via transport line 214 such that a subsequent batch of a suspension and a microbial mixture may be transported to incubation unit 210. In such embodiments, system 200 is configured for continuous cementing operations. Curing unit 216 may be configured to cure the cementing composition and, optionally, recover a fluid from the cementing composition (e.g., via recovery line 218). The fluid recovered from the cementing composition may be combined with transport line 212. The cured composite 220 may be passed through outlet 222 of cementing unit 204 via line 214 from incubation unit 210 or, when present, line 224 from curing unit 216.

### EXAMPLES

### Example 1

S. pasteurii was grown in shake flasks at 30° C. in ammonium-yeast extract (NH₄-YE) media to an optical density (OD) or about 1.0. Suspended cell cultures were harvested and used for MICP (microbe) treatment. U rease was extracted from the cell cultures to use for EICP (lysate) treatment. The efficacy of different sources of the crude enzyme were compared, including whole microbial lysates (cells including intracellular and extracellular enzymes) versus microbial supernatants, which included only the extracellular enzyme. Various methods of lysing microbes to release the enzyme were tested, including sonication and a lysis buffer.

### Example 2

Several liquid treatments were separately mixed with an iron ore material to form several cementing slurry compositions. Commercial jack bean enzyme was used as a liquid treatment for an EICP control. Other control treatments included the media used to grow the microbes (i.e., ammonia-yeast extract, NH₄-YE). For each treatment, the enzyme catalyst was added to a cementation solution that included a 0.5 M carbon source (urea), a 0.5 M calcium source (i.e., calcium acetate), and an iron ore substrate. Several other no-enzyme controls were included, such as cementation solution alone, NH₄-YE medium with cementation solution, lysis buffer, and lysis buffer with cementation solution. As shown in Table 1, below, several treatments were each evaluated at 4% and 6% by weight of moisture.

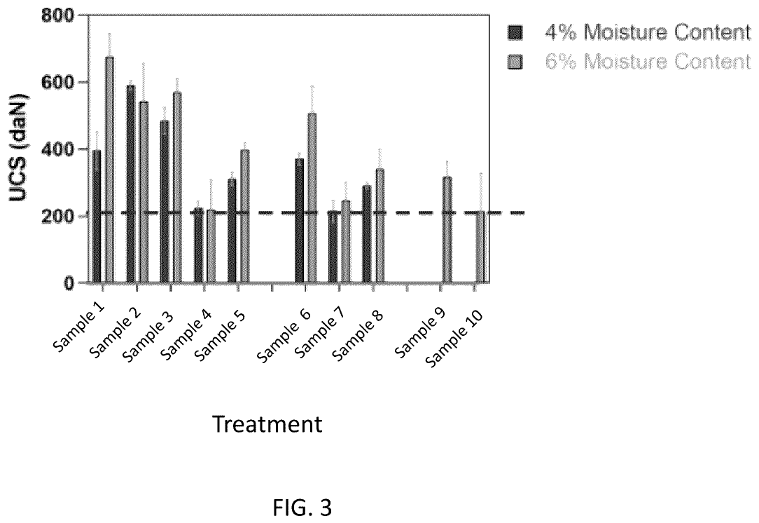

TABLE 1
Liquid Treatments Evaluated and Compiled in FIG. 3

| Sample No. | Liquid Treatment |
|---|---|
| Sample 1 | Microbe (MICP) |
| Sample 2 | Microbial lysate (EICP) |
| Sample 3 | Microbial supernatant (EICP) |
| Sample 4 | Microbial media (no cells) |
| Sample 5 | Microbial media and cementation solution (no cells) |
| Sample 6 | Microbes in lysis buffer (sonicated) |
| Sample 7 | Control-Lysis buffer |
| Sample 8 | Control-Cementation solution and lysis buffer |
| Sample 9 | Control-Commercial enzyme (EICP) |
| Sample 10 | Control-Cementation solution only |

Each cementation slurry was incubated and agglomerated using an automatic hydraulic press. Samples were immediately removed from the hydraulic press mold and cured for 3 days. The unconfined compressive strength (UCS) was measured using a Gilson HM-396 load frame by ISO Method 4700. UCS measurements for treatments performed at total of 4% by weight and 6% by weight initial moisture content of the treatment solutions to the iron ore substrate are shown in FIG. 3. FIG. 3 shows that at very low initial moisture conditions (i.e., 4% by weight), the EICP cell lysate of Sample 2 and Sample 3 outperforms the MICP microbe process of Ex. 1. At 6 wt % moisture content, the MICP cementation of Ex. 1 indicated a slightly improved compressive strength as compared to EICP Exs. 1 and 2. Notably, Sample 1 having 6 wt % moisture content and EICP Samples 2 and 3 (at both 4 wt % and 6 wt % moisture contents) significantly outperformed in UCS as compared to control Slurries 7 to 10.

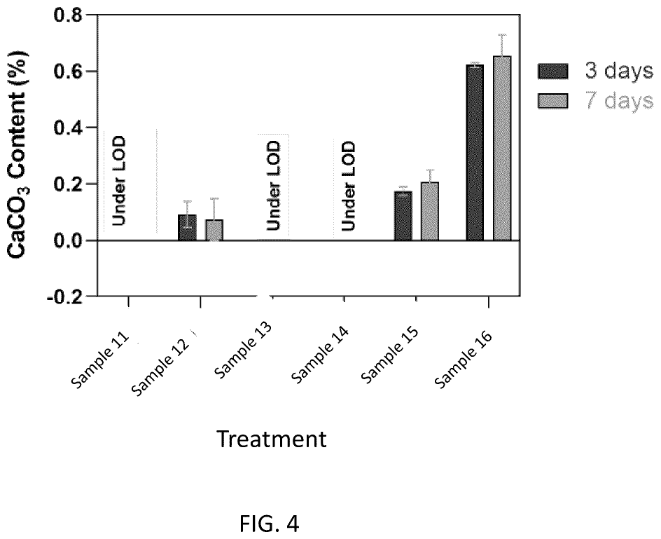

TABLE 2
Liquid Treatments Evaluated and Compiled in FIG. 4

| Sample No. | Liquid Treatment |
|---|---|
| Sample 11 | Control-Water |
| Sample 12 | Control-Cementation solution including only calcium |
| | source |
| Sample 13 | Control-Cementation solution including carbon source |
| Sample 14 | Control-Carbon source and enzyme⁺ without a calcium |
| | source |
| Sample 15 | Control-Calcium source and enzyme⁺ without a carbon |
| | source |
| Sample 16 | Inventive-EICP* |

⁺enzyme obtained from S. pasteurii as described in Example 1;
*enzyme obtained from S. pasteurii as described in Example 1 and combined with a cementation solution including both calcium and carbon sources

Calcium carbonate concentrations of various slurries were also evaluated after curing after 3 and 7 days. FIG. 4 shows the calcium carbonate concentrations of control versus EICP samples for agglomerates after 3 and 7 days, where “Under LOD” indicates under level-of-detection. These data in FIG. 4 show that the calcium carbonate concentrations were substantially identical at 3 and 7 days.

### Example 3

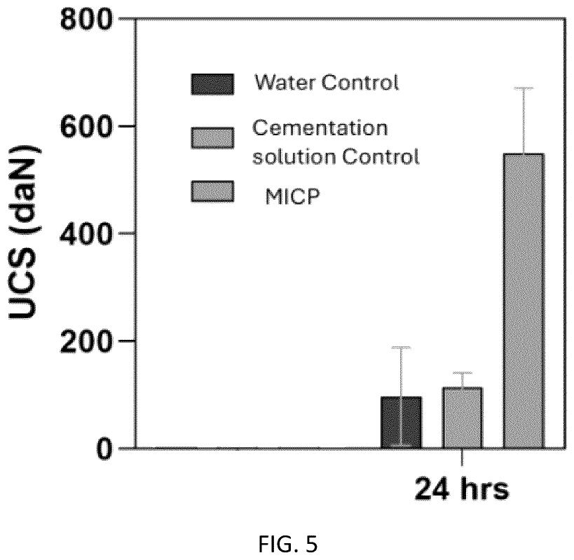

Follow-up cementing experiments with 3 different cementing slurries were performed. The 3 different cementing slurries were obtained by mixing an iron ore with 1) a water control cementing sample, 2) a cementation solution control (in the absence of microbes), and 3) an inventive MICP solution obtained as described in Example 1 and including the microbe. The slurries including the cementation solution without microbes and the inventive MICP solution each included a 0.5 M carbon source (urea) and 0.5M calcium source (calcium chloride). Each cementation slurry was incubated and agglomerated using an automatic hydraulic press. Samples were immediately removed from the hydraulic press mold and cured for 24 hours. The UCS was measured using a Gilson HM-396 load frame by ISO Method 4700. Results of the UCS experiments are shown in FIG. 5. As shown in FIG. 5, the strength of agglomerates generated by MICP at 24 hours is similar to that of agglomerates cured for 3 days as shown in FIG. 3.

### Example 4

An MICP formulation of fermentation broth obtained from S. pasteurii grown as described in Example 1 was combined with 0.5 M calcium acetate, 0.5 M urea, and xanthan gum (XG) at various concentrations (i.e., 0.04 wt %, 0.07 wt %, and 0.12 wt % based on the total weight of the cement slurry composition). Each fermentation broth were each mixed with iron ore to form final cementing slurry compositions had either 6 wt % or 10 wt % moisture based on the total weight of the cementing composition. These cementing compositions were compared to control compositions that only included iron ore, media (i.e., NH₄-YE), 0.5 M calcium acetate, 0.5M urea, and xanthan gum.

Each slurry was compressed at 20 kN (kiloNewtons) in a pellet press and then removed and cured at room temperature for 3 days. Post curing UCS of composite pellets was measured using a Gilson load frame and standard methods (e.g., ASTM D2850). Table 2 shows the slurry compositions that were compressed and evaluated.

TABLE 2
Cementing Sample Compositions Evaluated in Example 4

| Sample No. | Liquid Treatment | Moisture Content (wt %) |
|---|---|---|
| Sample 17 | Control-1 | 6 |
| Sample 18 | MICP (no XG) | 6 |
| Sample 19 | Media (0.04 wt % XG) | 6 |
| Sample 20 | MICP (0.04 wt % XG) | 6 |
| Sample 21 | Media (0.07 wt % XG) | 6 |
| Sample 22 | MICP (0.07 wt % XG) | 6 |
| Sample 23 | Control-2 | 10 |
| Sample 24 | MICP (no XG) | 10 |
| Sample 25 | Media (0.12 wt % XG) | 10 |
| Sample 26 | MICP (0.12 wt % XG) | 10 |

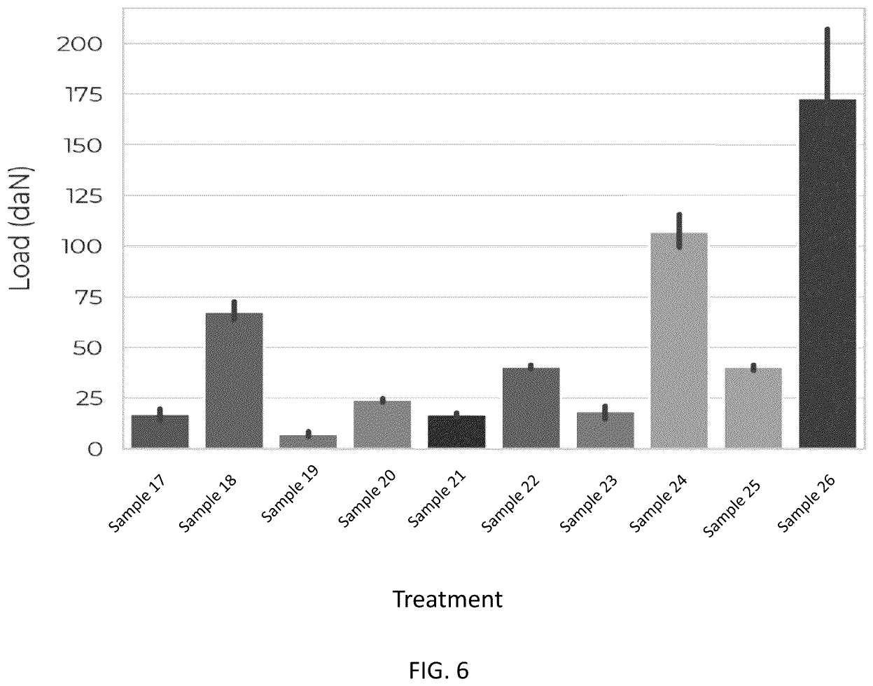

Results shown in FIG. 6 indicate that Sample 26 (i.e., a composition including MICP formulation with 10% by weight moisture and the addition of xanthan gum) significantly increases UCS relative to MICP treatment without XG of Samples 18 and 24 or control mixtures of XG with calcium acetate in microbial media without S. pasteurri microbes. Notably, the addition of XG to an MICP treatment significantly reduced the pressure conditions required to incubate the mixture (i.e., MICP with 20 kN with XG versus MICP with 200 kN without xanthan gum) and produce higher strength material as shown in FIG. 6.

### Example 5

Iron ore was mixed with various treatment solutions including fermentation broth from S. pasteurii, 2.5 wt % based on the total weight of the slurry composition, 0.5 M of a calcium source (e.g., calcium acetate or calcium chloride), 0.5 M urea, and 1.52% by weight of XG to create a final slurry composition of 9% by weight moisture. Each slurry was compressed at 20 kN in a pellet press, was removed, and cured at room temperature for 24 hours followed by an increase in temperature to 100° C. or 250° C. temperature for 30 minutes. Table 3 shows each slurry composition and temperature after curing.

TABLE 3
Slurry Compositions Evaluated

| | | Temperature After | Moisture Content |
|---|---|---|---|
| Sample No. | Calcium Source | Curing (° C.) | (wt %) |
| Sample 27 | Calcium acetate | 100 | 9 |
| Sample 28 | Calcium acetate | 100 | 9 |
| Sample 29 | Calcium acetate | 250 | 9 |
| Sample 30 | Calcium chloride | 100 | 9 |
| Sample 31 | Calcium chloride | 250 | 9 |
| Sample 32 | None* | 100 | 9 |
| Sample 33 | None* | 250 | 9 |

*Samples 32 and 33 was formulated using 50% XG and 50% SS with an MICP composition without a calcium source

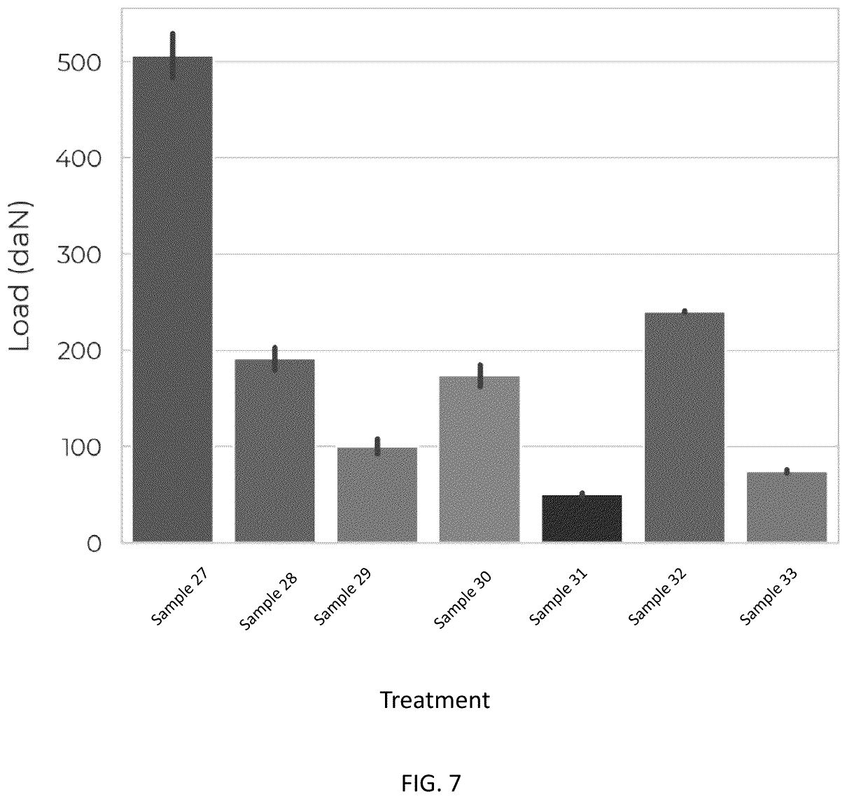

Post curing UCS of composite pellets was measured using a Gilson load frame and standard methods (e.g., ASTM D2850). Drop tests were also performed where pellets of the cemented composites were dropped from a 2 meter height and shattering of the pellets was assessed. Results compiled in FIG. 7 and Table 4, below, show that increased temperatures and addition of sodium silicate does not improve compressive strength.

TABLE 4
Drop test results

| | 100° C. after curing | | | 250° C. after curing | | |
|---|---|---|---|---|---|---|
| | Sample | Sample | Sample | Sample | Sample | Sample |
| | 28 | 30 | 32 | 29 | 31 | 33 |
| Number of | >4 | 3 | >4 | 4 | 1.5 | 2 |
| Drops to | | | | | | |
| Complete | | | | | | |
| Failure | | | | | | |
| Percent (%) | 35% ± 15% | NA | 54% ± 5% | 0% | NA | NA |
| Retained on | | | | | | |
| 10 mm after | | | | | | |
| 4 drops | | | | | | |

### Example 6

Fermentation broth from S. pasteurii grown as described in Example 1 was obtained and combined with 0.5 M calcium acetate, 0.5 M urea, 1.52% by weight of XG, and iron ore to produce a final inventive cementing composition (MICP+XG) having 10 wt % moisture. To a separate composition having 10 wt % total moisture and including iron ore, fermentation broth, 0.5M calcium acetate, 0.5M urea, 1.52% by weight of XG, sodium silicate (SS) was added at 3.5 wt % based on the total weight of the composition to form a composition “MICP+XG+3.5% SS”. To another composition having 10 wt % moisture and including iron ore, fermentation broth, 0.5M calcium acetate, 1.52% by weight of XG, calcium carbonate (CaCO₃) was added at 10% by weight to form a composition labelled “MICP+XG+CaCO₃”. A control sample having 10 wt % moisture, iron ore and 5 wt % SS was also produced.

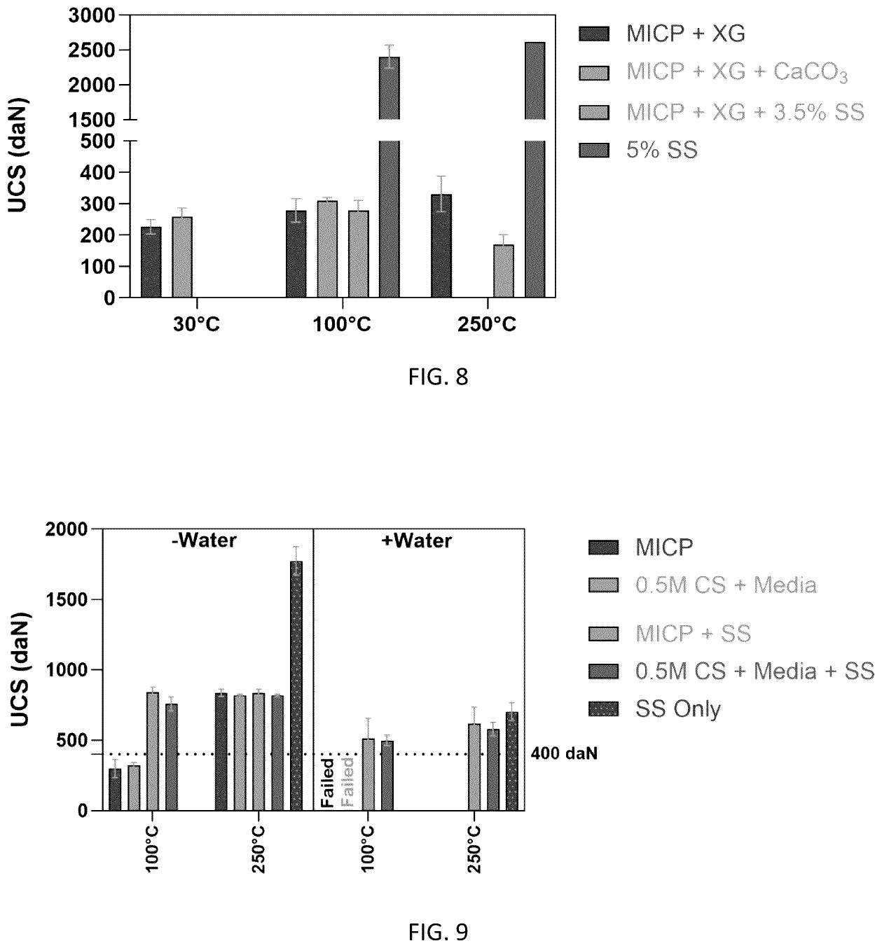

Each slurry was compressed at 20 kN in a pellet press and then removed and cured at room temperature (e.g., 22° C.) for 24 hours followed by bringing to 30° C., 100° C., or 250° C. temperature for 30 minutes. Post curing UCS of composite pellets was measured using a Gilson load frame and standard methods (e.g., ASTM D2850). Results in FIG. 8 show that increased temperatures and addition of SS or CaCO₃ did not improve compressive strength relative to the S. pasteurii MICP treatment with XG.

Fermentation broth was obtained S. pasteurii grown as described in Example 1 and was combined with 0.5 M calcium chloride, 0.5 M urea, and iron ore to produce a final inventive slurry composition including 6 wt % moisture content. Control slurries having 6 wt % moisture (labelled “0.5M CS+Media” and “0.5M CS+Media+SS” in FIG. 9) including iron ore, 0.5 M calcium chloride, 0.5 M urea, and S. pasteurii media were produced without the microbes. In several treatments sodium silicate (SS) was added at 2% weight based on the total weight of the slurry. A SS control slurry composition was also produced using 5 wt % and iron ore (labelled “SS only” in FIG. 9).

### Example 7

Each slurry was compressed at 200 kN in a pellet press and then removed and cured at room temperature for 24 hours followed by an increase in temperature to 100° C. or 250° C. temperature. The increased temperature was held at these values for 30 minutes. Post curing UCS of composite pellets was measured using a Gilson load frame and standard methods (e.g., ASTM D2850). Cured samples were measured in the presence (“+water”) and in the absence (“−water”) of water. For “+water” samples, the samples were put in a tub of water for 3 days and then removed for UCS measurements after heating.

FIG. 9 shows the UCS results obtained for each cured composite produced in the absence and presence of water. As shown in FIG. 9, SS generally improved strength of the composite pellets. Additionally, the samples including SS with calcium chloride led to water resistance. However, the MICP sample (including only the fermentation broth obtained from S. pasteurii) did not significantly increase UCS.

### Example 8

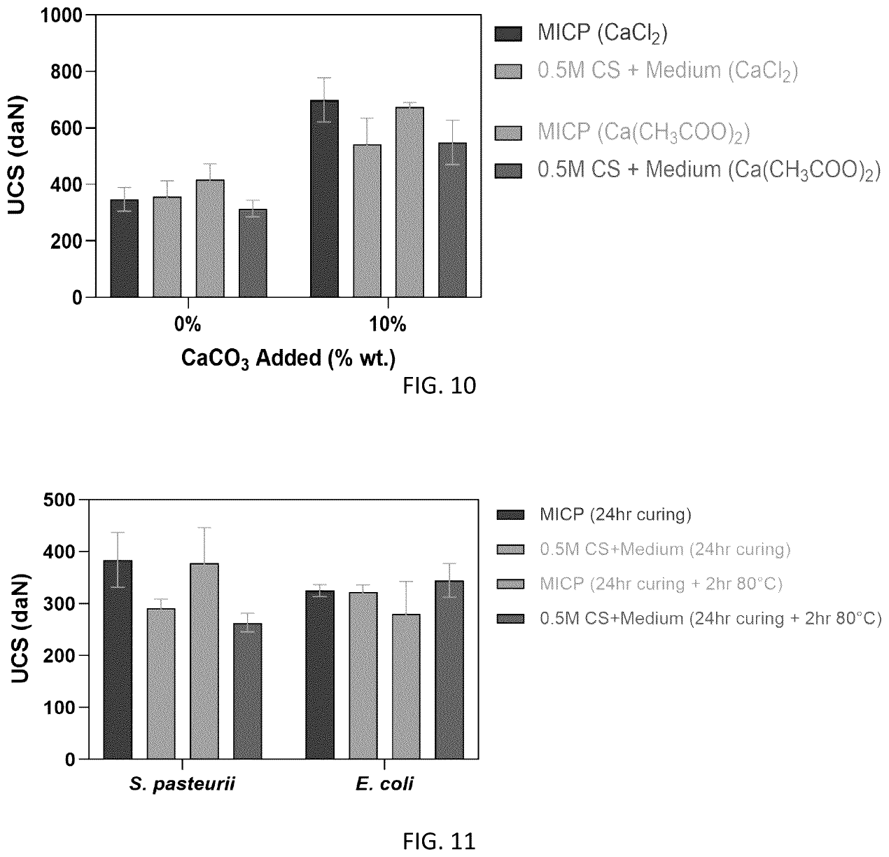

Fermentation broth from S. pasteurii produced as described in Example 1 was mixed with 0.5 M calcium chloride (CaCl₂) or calcium acetate (Ca(CH₃COO)₂), 0.5 M urea, and iron ore to produce a final inventive composition of 6 wt % moisture slurry. Control slurries having 6 wt % moisture were produced with iron ore, 0.5 M calcium chloride, 0.5 M urea, and S. pasteurii media without the microbes (labelled “0.5M CS+Medium” in FIG. 10). In several treatments, CaCO₃ was added at 10 wt % based on the total weight of the slurry.

Each slurry was compressed at 200 kN in a pellet press and then removed and cured at room temperature for 24 hours. Post curing UCS of composite pellets was measured using a Gilson load frame and standard methods (e.g., ASTM D2850).

Drop tests were also performed where pellets of the cemented composites were dropped from a 2 meter height and shattering of the pellets was assessed. Results compiled in FIG. 10 and Table 5, below, show that increased temperatures and addition of sodium silicate does not improve compressive strength. As shown in FIG. 10, SS improved strength of the pellets and the SS with CaCl₂ led to water resistance. The S. pasteurii did not significantly increase strength.

TABLE 5
Drop test results

| | | | | | | | 0.5M CS + | |
|---|---|---|---|---|---|---|---|---|
| | MICP CaCl₂ | | 0.5M CS + Media CaCl₂ | | MICP Ca(CH₃COO)₂ | | Media Ca(CH₃COO)₂ | |
| | 0% | 10% | 0% | 10% | 0% | 10% | 0% | 10% |
| | CaCO₃ | CaCO₃ | CaCO₃ | CaCO₃ | CaCO₃ | CaCO₃ | CaCO₃ | CaCO₃ |
| Number of | Not | 2 | Not | 2 | >4 | >4 | 2 | 3 |
| Drops to | determined; | | determined; | | | | | |
| Complete | Historical | | Historical | | | | | |
| Failure | data: 1 | | data: 1 | | | | | |
| Percent (%) | Not | 0 | Not | 0 | 22% | 0 | 0 | 0 |
| Retained on | determined; | | determined; | | | | | |
| 10 mm after | Historical | | Historical | | | | | |
| 4 drops | data: 0% | | data: 0% | | | | | |

Fermentation broth from S. pasteurii prepared as described in Example 1 was combined with 0.5 M CaCl₂, 0.5 M urea, and iron ore to produce a final inventive slurry composition having 6 wt % moisture. The same growth medium was used to grow E. coli for comparative tests.

### Example 9

Control slurry compositions having 6 wt % moisture and having iron ore, 0.5M CaCl₂ and 0.5 M carbon source (urea) with S.pasteurii media (labelled “0.5M CS+Medium” in FIG. 11) were produced without the microbes. Additional control slurry compositions using a non-urease producing organism E. coli were formed and evaluated for UCS under the same conditions.

Each slurry was compressed at 200 kN in a pellet press and then removed and cured at room temperature for 24 hours. A second series of composite pellets were compressed and, cured at room temperature for 24 hours, and further heated to 80° C. for 2 hours. Post curing UCS of composite pellets was measured using a Gilson load frame and standard methods (e.g., ASTM D2850). As shown in FIG. 11, no difference was observed between samples prepared with E. coli MICP and control treatments. In contrast, the results indicate that S. pasteurii MICP treatments were stronger than controls samples evaluated.

### Example 10

Fermentation broth S. pasteurii was either grown in a shake flask for 24 or 48 hours, a fermentor for 24 or 48 hours, or in a shake flask with 2 wt % glucose (2% Glu) for 48 hours. Fermentation broth of S. pasteurii from each growth source was obtained as described in Example 1. Each fermentation broth was mixed with 0.5 M CaCl₂, 0.5 M urea, and iron ore to form an inventive slurry composition having 6 wt % moisture slurry to provide inventive “MICP” samples. Control samples having 6% moisture slurry and iron ore, 0.5 M CaCl₂, 0.5 M urea, and S. pasteurii media were produced without the microbes.

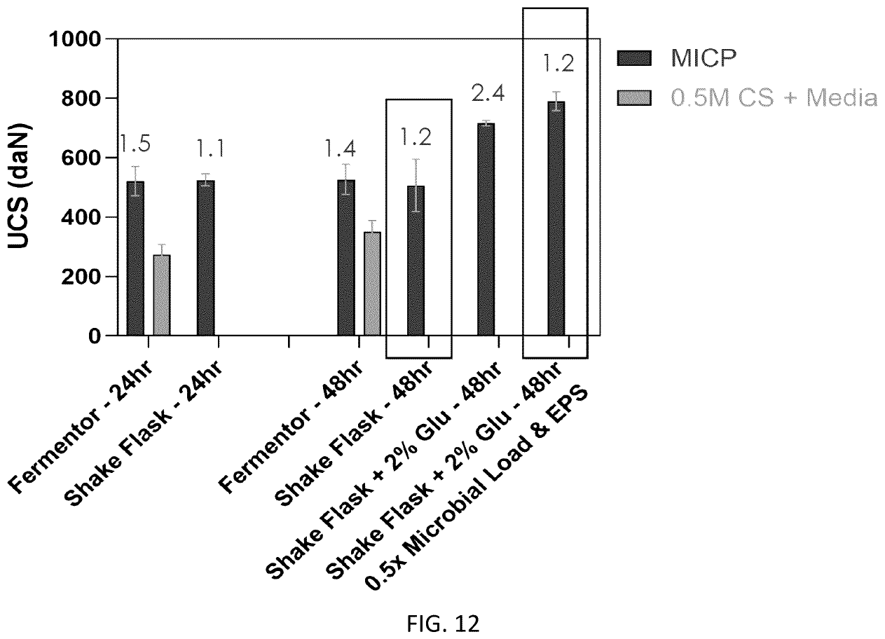

Each slurry was compressed at 200 kN in a pellet press and then removed and cured at room temperature for 24 or 48 hours. Post curing UCS of composite pellets was measured using a Gilson load frame and standard methods (e.g., ASTM D2850). FIG. 12 shows a comparison of UCS of different composite pellets formed from S. pasteurii grown under different conditions (i.e., in a shake flask versus a fermenter). As shown in FIG. 12, altering the growth of S. pasteurri impacted the strength of the biocement, where MICP treatments in a shake flask demonstrated increased compressive strength as compared to S. pasteurii grown in a fermentor.

### Example 11

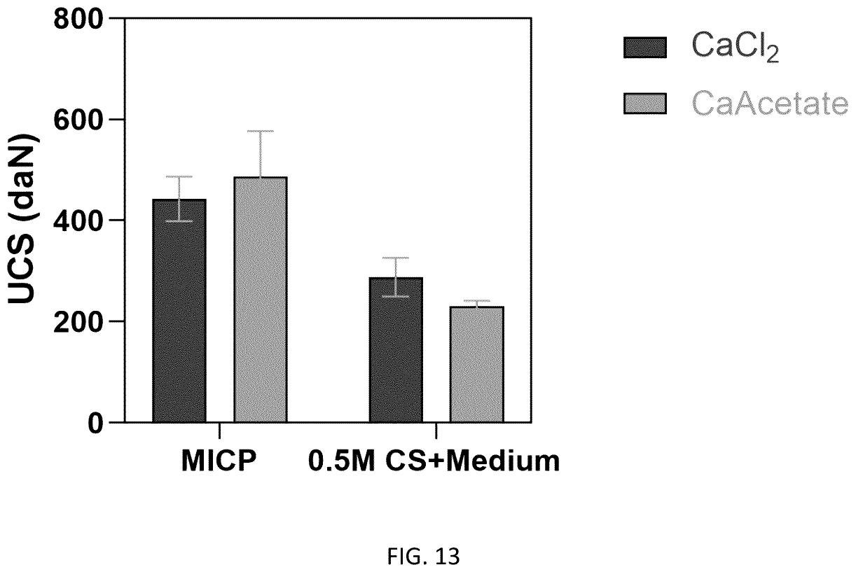

Fermentation broth from S. pasteurii obtained as described in Example 1 was mixed with either 0.5 M CaCl₂ or 0.5 M Ca(CH₃COO)₂, 0.5 M urea, and iron ore to produce a final inventive “MICP” slurry compositions having 6 wt % moisture. Control slurry compositions having 6 wt % moisture of 0.5M CaCl₂ or 0.5M Ca(CH₃COO)₂, 0.5 M urea with S. pasteurri media were formed without the microbes (labelled “0.5M CS+Medium” in FIG. 13). Each slurry was compressed at 200 kN in a pellet press and then removed and cured at room temperature for 72 hours. Post curing UCS of composite pellets was measured using a Gilson load frame and standard methods (e.g., ASTM D 2850). As shown in FIG. 13, the measured data indicates that both CaCl₂ and Ca(CH₃COO)₂ are beneficial calcium ion sources.

### Example 12

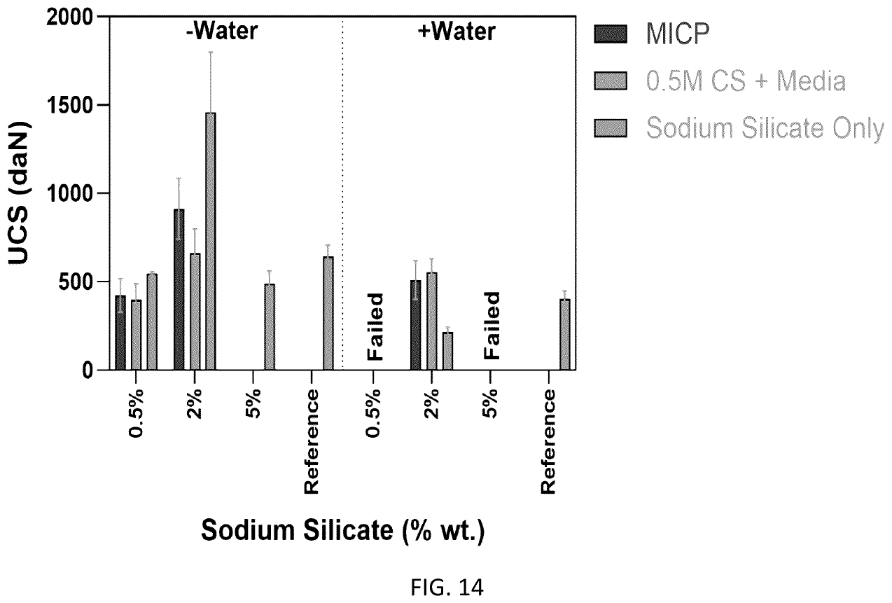

Fermentation broth from Sporosarcina pasteurii obtained as described in Example 1 was mixed with 0.5 M CaCl₂, 0.5 M urea, and iron ore to produce a final slurry composition having 6 wt % total moisture as an inventive “MICP” sample. Control slurry compositions having 6 wt % total moisture and iron ore, 0.5 M CaCl₂ or 0.5 M Ca(CH₃COO)₂, 0.5 M urea, and S. pasteurii media were run without the microbes (labelled “0.5M CS+Medium” in FIG. 14). SS was added to MICP treatment and control solutions at 0.5, 2, and 5 wt %. Control slurry compositions having 6 wt % total moisture were also formed with only SS and iron ore (labelled “Sodium Silicate Only” in FIG. 14), where SS was added to treatments solutions at 0.5 wt %, 2 wt %, or 5 wt % based on the total weight of the slurry compositions.

Each slurry was compressed at 200 kN in a pellet press and then removed and cured at room temperature for 24 hours. Post curing UCS of composite pellets was measured using a Gilson load frame and standard methods (e.g., ASTM D2850). Composite pellets were also cured from each slurry and further subjected to exposure to water. Pellets were submerged in containers that included tap water at room temperature (e.g., 22° C.) for at least 24 hours (labelled “+water” in FIG. 14). UCS was determined based on samples in the absence of further exposure to water and in the presence of water. FIG. 14 shows the resultant U CS data of the composite pellets. The data shown in FIG. 14 indicates that water resistance is improved with 2 wt % SS. In addition, MICP showed increased strength compared to controls at the 2 wt % SS addition.

### Example 13

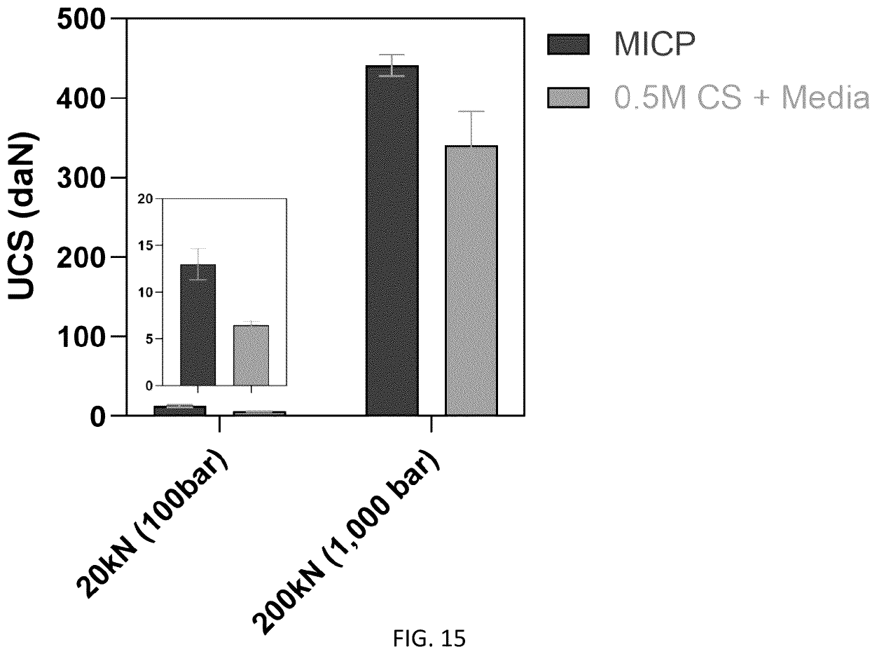

Fermentation broth from Sporosarcina pasteurii obtained as described in Example 1 was mixed with 0.5 M CaCl₂, 0.5 M urea, and iron ore to produce a final slurry composition having 6 wt % total moisture as an inventive “MICP” sample. Control slurry compositions including iron ore, 0.5M CaCl₂ or 0.5 M Ca(CH₃COO)₂, 0.5 M urea, and S. pasteurri media were run without the microbes (labelled as “0.5M CS +Media” in FIG. 15).

Each slurry composition was compressed at either 20 kN or 200 kN in a pellet press and then removed and cured at room temperature for 24 hours. Post curing UCS of composite pellets was measured using a Gilson load frame and standard methods (e.g., ASTM D2850). As shown in FIG. 15, the inventive MICP treatment increases UCS regardless of the compression force. It was also observed that compression force during incubation significantly impacts UCS.

### Example 15

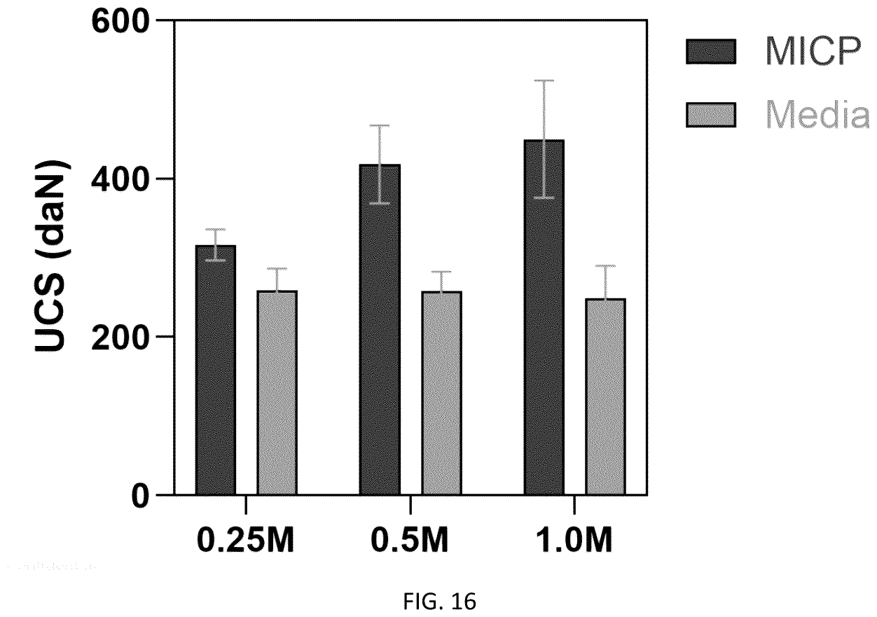

Fermentation broth from Sporosarcina pasteurii obtained as described in Example 1 was mixed with various concentrations of CaCl₂ (i.e., 0.25 M, 0.5 M, and 1.0 M concentrations), 0.5 M urea, and iron ore to produce a final slurry composition having 6 wt % total moisture. Control slurry compositions having 6 wt % total moisture and various concentrations of CaCl₂ (i.e., 0.25 M, 0.5 M, and 1.0 M concentrations), 0.5 M urea, iron ore, and S. pasteurri media were produced without the microbes. Control samples evaluated are labelled “Media” in FIG. 16.

Each slurry composition was compressed at 200 kN in a pellet press and then removed and cured at room temperature for 24 hours. Post curing UCS of composite pellets was measured using a Gilson load frame and standard methods (e.g., ASTM D 2850). FIG. 16 shows results of UCS experiments. The data shown in FIG. 16 indicates that 0.5 M CaCl₂ is sufficient to provide a calcium ion source for MICP under these conditions with improved UCS as compared to control samples.

### Example 15

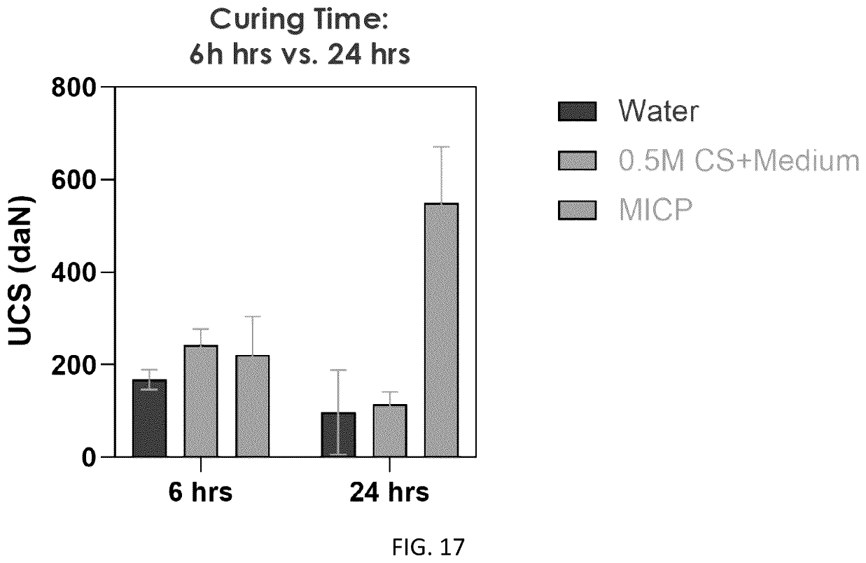

Fermentation broth from Sporosarcina pasteurii obtained as described in Example 1 was mixed with 0.5 M CaCl₂, 0.5 M urea, and with iron ore to produce a final slurry composition having 6 wt % total moisture to provide an inventive sample (i.e., an “MICP” sample). Control slurry compositions without the microbes and having 6 wt % total moisture were produced with 0.5M calcium chloride, 0.5 M urea, iron ore, and with S. pasteurri media. Additional control samples were produced with iron ore and water only to provide 6 wt % total moisture. Control slurry compositions are labelled as “0.5M CS+Medium” and “water” in FIG. 17.

Each slurry was compressed at 200 kN in a pellet press and then removed and cured at room temperature for either 6 hours or 24 hours. Post curing UCS of composite pellets was measured using a Gilson load frame and standard methods (e.g., ASTM D2850). FIG. 17 shows the results of compressive strength experiments. The data shown in FIG. 17 indicates that a significant increase in compressive strength is observed after 24 hours with the inventive M ICP treatment. In contrast, 6 hours of curing time was determined to not be effective to observe an increase in strength as compared to control samples.

### Example 17

Sporosarcina pasteurii was stored post growth for 2 weeks. Urease activity was measured over time to assess stability. Tables 6 and 7 show conditions and results for a stability trials over 14 days.

TABLE 6
Conditions and Results for a Stability Trial over 14 Days

| | Temperature | Urease Activity |
|---|---|---|
| Days | (° C.) | (mM Urea/min) |
| 0 | — | 1.17 ± 0.07 |
| 1 | 4 | 1.04 ± 0.03 |
| 14 | 4 | 1.14 ± 0.06 |

TABLE 7
Conditions and Results for a Stability Trial over 14 Days

| | Temperature | Urease Activity |
|---|---|---|
| Days | (° C.) | (mM Urea/min) |
| 0 | — | 1.04 ± 0.08 |
| 2 | 4 | 1.08 ± 0.07 |
| | 20 | 1.08 ± 0.05 |
| | 30 | 1.37 ± 0.03 |
| 7 | 4 | 1.024 ± 0.02 |
| | 20 | 1.30 ± 0.02 |
| | 30 | 1.23 ± 0.06 |
| 14 | 4 | 1.10 ± 0.03 |
| | 20 | 1.27 ± 0.07 |
| | 30 | 0.62 ± 0.04 |

As shown in Tables 6 and 7, S. pasteurii urease activity remained stable at 4° C. and 20° C. for 2 weeks.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for rapid biocementation of a material under low moisture conditions, the method comprising:
(A) mixing a cell lysate of a urease-producing microbe with the material and, optionally, a calcium source and/or a carbon source, under initial moisture conditions of less than about 15% by weight to form a cementing composition;
(B) incubating the cementing composition for a selected time under pressure conditions of between 0 to 1500 bars to form an incubated mixture; and
(C) curing the incubated mixture for hours to weeks.

2. The method of claim 1, wherein the material comprises a metal ore.

3. The method of claim 1, wherein the material comprises iron ore and/or the urease-producing microbe comprises Sporosarcina pasteurii (S. pasteurii), Sporosarcina spp., Bacillus subtilis, Bacillus amyloliquefaciens, Bacillus thuringiensis, Bacillus lentus, Bacillus fortis, Bacillus pumilus, Bacillus megaterium, Bacillus sphaericus, Bacillus cereus, Bacillus mucilaginosus, Lysinibacillus fusiformis, Lysinibacillus xylanilyticus, Pseudogracilibacillus auburnensis, Viridibacillus arvi.

4. The method of claim 1, wherein the initial moisture conditions are in a range of about 3% by weight to about 10% by weight.

5. The method of claim 1, wherein the curing is in a range of about 15 minutes to about 24 hours.

6. The method of claim 1, further comprising in step (A) mixing the cell lysate and the material with a viscosity modifying agent in an amount of about 5% by weight or less of the cementing composition.

7. The method of claim 6, wherein the viscosity modifying agent comprises one or more selected from xanthan gum, sodium silicate, and bentonite.

8. The method of claim 1, wherein the incubating the cementing composition comprises:
introducing the cementing composition to a press mold; and
operating the press mold to apply pressure.

9. A method for rapid biocementation of a material under low moisture conditions, the method comprising:
(A) mixing a whole cell microbe fermentation product of a urease-producing microbe with the material and, optionally, a calcium source and/or a carbon source, under initial moisture conditions of less than about 15% by weight to form a cementing composition;
(B) incubating the cementing composition for a selected time to form an incubated mixture; and
(C) curing the incubated mixture for days to weeks.

10. The method of claim 9, wherein the material comprises a metal ore and/or the urease-producing microbe comprises Sporosarcina pasteurii.

11. The method of claim 9, wherein the initial moisture conditions are in the range of about 3% by weight to about 10% by weight.

12. The method of claim 9, wherein the curing is at least about 48 hours.

13. The method of claim 9, further comprising in step (A) mixing the whole cell microbe fermentation product and the material with a viscosity modifying agent in an amount of about 5% by weight or less of the cementing composition.

14. The method of claim 9, wherein the incubating the cementing composition further comprises incubating the cementing composition under pressure conditions of between 0 to 1500 bars, and wherein the cementing composition is introduced to a press mold and the press mold is operated to apply pressure.

15. A method for separating an ore material from a suspension, the method comprising:
biocementing the ore material of the suspension,
wherein biocementing the ore material comprises:
mixing a cell lysate of a urease-producing microbe, a whole cell microbe fermentation product of a urease-producing microbe, a calcium source, a carbon source, or combinations thereof with the ore material to form a cementing composition;
incubating the cementing composition for a selected time under pressure conditions in a range from 0 bar to 1500 bar, thereby initiating agglomeration of the ore material and forming an incubated mixture; and
curing the incubated mixture for hours to weeks.

16. The method of claim 15, further comprising in step (A) mixing the cell lysate and/or the whole cell microbe fermentation product and the ore material with a viscosity modifying agent in an amount of about 5% by weight or less of the cementing composition.

17. The method of claim 15, wherein incubating the cementing composition comprises applying pressure conditions of between 0 to 1500 bars.

18. The method of claim 17, wherein the incubating the cementing composition comprises:
introducing the mixture to a press mold; and
operating the press mold to apply pressure.

19. The method of claim 15, wherein the biocementing further comprises:
biocementing the ore material prior to passing a suspension comprising the ore material through a filter of a filtration device; and/or
biocementing the ore material when the ore material is present in a filter cake on a filter of the filtration device.

20. The method of claim 15, further comprising:
reducing a moisture content of a suspension comprising the ore material and a carrier fluid prior to biocementing the ore material.
